(19) United States
(12) Patent Application Publication
(10) Pub. No.: US 2026/0009747 A1
(43) Pub. Date: Jan. 8, 2026

(54) Systems and Methods for Enhanced Material Classification Using On-The-Fly Energy Thresholding

(71) Applicant: Rapiscan Holdings, Inc., Hawthorne, CA (US)

(72) Inventor: Mark Procter, Wilmslow (GB)

(21) Appl. No.: 19/256,423

(22) Filed: Jul. 1, 2025

Related U.S. Application Data
(60) Provisional application No. 63/666,796, filed on Jul. 2, 2024.

(51) Int. Cl. G01N 23/083; G01N 23/04

(52) U.S. Cl. CPC G01N 23/083; G01N 23/04

(57) ABSTRACT

X-ray scanning systems include a source operating in first and second modes and a detector for receiving X-ray photons released from a first object and a second object during the first mode and second mode, respectively. A processor implements a first binning scheme in response to the first mode to determine a first count of X-ray photons. When the source is triggered to operate in the second mode, the processor generates a second binning scheme. An object is swept once in the second mode and the processor determines a second count of X-ray photons using the second binning scheme. If two or more lower energy-resolving bins in the second binning scheme have photon counts of zero, the processor generates a third binning scheme. The object is continued to be scanned in the second mode and the processor determines a third count of X-ray photons using the third binning scheme.

### CROSS-REFERENCE

The present application relies on, for priority, U.S. Patent Provisional Application No. 63/666,796, titled “Systems and Methods for Enhanced Material Classification Using Dynamic On-The-Fly Energy Thresholding” and filed on Jul. 2, 2024, which is herein incorporated by reference in its entirety.

### FIELD

The present specification is related generally to the field of ionizing radiation-based scanning or imaging systems. More specifically, the present specification is related to energy-resolving imaging systems that provide enhanced material classification with the use of on-the-fly energy thresholding.

### BACKGROUND

Current security screening applications use X-ray transmission imaging to generate high-penetration, high-resolution images of cargo, vehicles, and pallets. X-rays are generated by either a high-energy linear accelerator or a low-energy X-ray tube assembly. The X-rays, comprising a spectrum of energies that range from ˜1 keV to a maximum value governed by the acceleration of the electron beam within the device, are incident upon an object under inspection. X-rays are attenuated, following the relationship outlined by the Beer Lambert equation, such that the X-ray signal on the far side of the object under inspection reflects the density composition of the object's components.

X-ray signals are measured by one or more detector arrays, the dimensions of which contribute towards the resolution of the resulting image. Typically, the detectors are inorganic scintillating crystals, with decay times on the order of approximately 1 μs (micro-second). The optical signal generated through the scintillation process is converted to an electrical signal through a photodiode, again operating with a response time of approximately 1 μs.

The above approach is useful when the total scintillation signal from many interacting X-rays is integrated into a single measurement. This single measurement reflects the total “intensity” of the beam that has passed through the object under inspection. However, in this approach, all of the information pertaining to the distribution of X-ray energies within the polychromatic beam is lost. Consequently, it is not possible to infer anything beyond the “amount” of any given material in the path of the X-rays. Conventionally, to determine any additional information relating to the composition of the attenuating material one of two approaches can be taken.

In a first approach, the source may be operated in a “dual-energy” mode. This is limited to pulsed sources, such as linear accelerators, where the acceleration of the electron beam can be modulated from one pulse to the next, providing interlaced beams of differing energy-typically 6 MeV and 4 MeV. A first view 100a, of FIG. 1A, is illustrative of the first approach showing a plurality of pulses 102a interlaced with high and low energies. Plot 104a shows a typical intensity-energy distribution of a high-energy X-ray beam while plot 106a shows a typical intensity-energy distribution of a low-energy X-ray beam.

A second approach employs a combination of multiple, stacked detectors that can measure a predominantly high-energy and predominantly low-energy contribution from the polychromatic, but “single end-point energy” beam. Typically, these configurations are used in systems with continuous beam X-ray tube assemblies, where energy interlacing is not possible, operating anywhere from 50 to 600 keV in end-point-energy. A second view 100b, of FIG. 1A, is illustrative of the second approach showing a first detector element having a front low-energy scintillator crystal 102b and a rear high-energy scintillator crystal 106b, both of which are coupled to respective photodetectors and mounted on a printed circuit board (PCB), and wherein the front low-energy scintillator crystal 102b is positioned closer to a first X-ray beam 104b. A second detector element having a front low-energy scintillator crystal 108b and a rear high-energy scintillator crystal 112b, both of which are coupled to respective photodetectors and mounted on a PCB, and wherein the front low-energy scintillator crystal 108b is positioned closer to a second X-ray beam 110b is also shown. The first X-ray beam 104b has an energy ranging from about 160 to 320 keV while the second X-ray beam 110b has an energy ranging from about 2 to 3 MeV. Consequently, for the first X-ray beam 104b, the front low-energy scintillator crystal 102b has a dimension (in the direction of the incoming beam) of about 2 mm and the rear high-energy scintillator crystal 106b has a dimension (in the direction of the incoming beam) of about 12 mm. Comparatively, for the second X-ray beam 110b (which has a higher energy range than the first X-ray beam 104b), the front low-energy scintillator crystal 108b has a dimension (in the direction of the incoming beam) of about 10 mm and the rear high-energy scintillator crystal 112b has a dimension (in the direction of the incoming beam) of about 25 mm. That is, the dimension of the scintillator crystal (in the direction of the incoming beam) varies and depends on the energy of the incident X-ray beam.

Both of the aforementioned approaches take a ratio of the measurements obtained at the two energies to determine a rudimentary level of material classification, which typically includes three broad categories: low-Z organic, medium-Z inorganic (or mixed), and high-Z metallic. FIG. 1B shows an example of an X-ray image 120b generated using the second approach, where organics are highlighted in a first color (such as orange), inorganic (or mixed) in a second color (such as green) and metallic in a third color (such as blue). There are, however, several shortcomings with the first and second approaches, which are described in the following paragraphs.

The existing techniques do not provide a true separation of energies but instead provide an “average” energy separation. Neither of the existing solutions is optimized for energy separation: 1) the use of the interlaced 4 MeV and 6 MeV beams only show a significant difference between the 4 MeV and 6 MeV energies and 2) the use of stacked detectors results in a large portion of high-energy X-rays interacting within the thin low-energy detector. This is illustrated in FIG. 1C showing first, second, third, fourth and fifth plots of intensity-energy distribution of low-energy polychromatic multi-energy sources having first, second, third, fourth and fifth end-point energies 102c, 104c, 106c, 108c, 110c, respectively, where the fifth energy is greater than the fourth energy, the fourth energy is greater than the third energy, the third energy is greater than the second energy and the second energy is greater than the first energy.

The techniques are susceptible to minor fluctuations in X-ray energy and intensity output during the period of a single scan due to low levels of separation between materials in the different classifications. The fluctuations correspond to 5% of drift in dose throughout the length of a scan. This is true across the full range of X-ray energies used in cargo and vehicle applications, but more so in higher energy (on the order of MeV) systems. For high-energy systems, the need to pulse an X-ray source twice, in close temporal proximity, to generate the required data for classification, impacts overall system performance and throughput. Penetration performance requires high-energy X-rays (the low-energy pulse needed for material classification penetrates significantly less material) and high-throughput requires high-frequency imaging at a single energy (the low-energy pulse drops this by a factor of 2). For low-energy systems, using a stacked detector assembly drives cost, complexity, and a large form factor. Multiple detectors require multiple photodiodes, data acquisition electronics and readout hardware, which is costly and space consuming. At the same time, low-energy scatter contributes towards the signal measured in the front detector of the stacked array, further reducing the quality of the low-energy signal used in determining the material composition.

Next generation low-energy products that operate X-ray sources at different energies depending upon the type of scan being performed, are restricted to a fixed stacked detector configuration for their energy separation. The crystal dimensions can only be optimized for one mode of operation, resulting in poorer material classification performance. Referring back to FIG. 1C, the required low and high-energy crystal dimensions 115c need to increase as there is a shift from the sources having first, second, third, fourth and fifth end-point energies 102c, 104c, 106c, 108c, 110c.

Material classification relies on effective atomic number and density derived from energy-resolved resolution data. Dual-energy X-ray system face limitations in resolving multiple stacked materials due to non-commutative beam-hardening effects, which complicate attenuation coefficient deconvolution. Multi-energy approaches overcome this by affording an analysis of data across multiple energy regimes, enabling accurate compositional analysis of obscured materials within the object under inspection through enhanced spectral separation.

The solutions that do exist use “multi-energy” spectrometers, such as energy-resolving solid-state detector materials coupled to high-speed, multi-channel data acquisition systems. However, idealistic solutions of this type are extremely expensive, difficult to deploy in harsh environments with wildly fluctuating temperatures and humidity, consume vast amounts of power and generate large amounts of heat. The aggregate of this additional complexity prevents the use of such multi-energy systems in cargo and vehicle inspection modalities.

Accordingly, there is need for an optimized energy-resolving solution that combines elements of the spectral capabilities of solid-state detectors, while maintaining deployable and commercial feasibility.

### SUMMARY

The following embodiments and aspects thereof are described and illustrated in conjunction with systems, tools and methods, which are meant to be exemplary and illustrative, and not limiting in scope. The present application discloses numerous embodiments.

The present specification discloses a computer implemented method for scanning an object, wherein the method is implemented by a plurality of programmatic instructions stored in a non-transient memory and wherein, when executed by at least one processor, the plurality of programmatic instructions cause: an X-ray source to sweep the object with a first X-ray beam; a first set of energy-resolving bins to be generated, wherein each of the first set of energy-resolving bins is defined by an energy range and is configured to receive data indicative of photons detected by a detector assembly as a result of the first X-ray beam interacting with the object; said data indicative of the photons in each of the first set of energy-resolving bins to be analyzed; a second set of energy-resolving bins to be generated based on said analysis, wherein at least one of a) a number of the second set of energy-resolving bins is different than a number of the first set of energy-resolving bins and b) one or more of the second set of energy-resolving bins is defined by an energy range that is different than one or more of the energy ranges of the first set of energy-resolving bins; and the X-ray source to sweep the object with a second X-ray beam.

Optionally, said data indicative of the photons in each of the first set of energy-resolving bins is analyzed by counting the photons in each of the first set of energy-resolving bins.

Optionally, said second set of energy-resolving bins is generated only if two or more of the first set of energy-resolving bins has a count of said photons below a threshold number. Still optionally, the threshold number is 1.

Optionally, the first set of energy-resolving bins comprises at least 5 bins and the second set of energy-resolving bins comprises at least 5 bins.

Optionally, at least a portion of the energy ranges of the second set of energy-resolving bins is shifted to different values relative to the energy ranges of the first set of energy-resolving bins.

Optionally, the X-ray source is a high-energy X-ray source and wherein the first X-ray beam has an end-point energy ranging from 50 to 600 keV.

Optionally, the object is a portion of a cargo vehicle that is not occupied by a human being.

Optionally, when executed by the at least one processor, the plurality of programmatic instructions further cause: a low-energy X-ray source to sweep a portion of the cargo vehicle that is occupied by a human being with a low-energy X-ray beam prior to the high-energy X-ray source sweeping the object with the first X-ray beam; and a third set of energy-resolving bins to be generated, wherein each of the third set of energy-resolving bins is defined by an energy range and is configured to receive data indicative of photons detected by the detector assembly as a result of the low-energy X-ray beam interacting with the occupied portion of the cargo vehicle.

Optionally, at least one of a) a number of the third set of energy-resolving bins is different than the number of the first set of energy-resolving bins or the number of the second set of energy-resolving bins and b) one or more of the third set of energy-resolving bins is defined by an energy range that is different than one or more of the energy ranges of the first set of energy-resolving bins or one or more of the energy ranges of the second set of energy-resolving bins.

In some embodiments, the present specification discloses an X-ray scanning system for scanning an object, comprising: an X-ray source comprising a first X-ray beam and a second X-ray beam; a detector assembly positioned to receive X-ray photons generated as a result of the first X-ray beam interacting with the object during a first scan mode and X-ray photons generated as a result of the second X-ray beam interacting with the object during a second scan mode; at least one processor in data communication with the X-ray source and the detector assembly, wherein the at least one processor is configured to execute a plurality of programmatic instructions to: sweep the object with the first X-ray beam generated by the X-ray source; cause a first set of energy-resolving bins to be generated, wherein each of the first set of energy-resolving bins is defined by an energy range and is configured to receive data indicative of the X-ray photons detected by a detector assembly as a result of the first X-ray beam interacting with the object; analyze said data indicative of the first X-ray photons in each of the first set of energy-resolving bins; cause a second set of energy-resolving bins to be generated based on said analysis, wherein at least one of a) a number of the second set of energy-resolving bins is different than a number of the first set of energy-resolving bins and b) one or more of the second set of energy-resolving bins is defined by an energy range that is different than one or more of the energy ranges of the first set of energy-resolving bins; and sweep the object with the second X-ray beam generated by the X-ray source.

Optionally, said data indicative of the photons in each of the first set of energy-resolving bins is analyzed by counting the photons in each of the first set of energy-resolving bins.

Optionally, said second set of energy-resolving bins is generated only if two or more of the first set of energy-resolving bins has a count of said photons below a threshold number.

Optionally, the threshold number is 1.

Optionally, the first set of energy-resolving bins comprises at least 5 bins and the second set of energy-resolving bins comprises at least 5 bins.

Optionally, at least a portion of the energy ranges of the second set of energy-resolving bins is shifted to different values relative to the energy ranges of the first set of energy-resolving bins.

Optionally, the X-ray source is a high-energy X-ray source and wherein the first X-ray beam has an end-point energy ranging from 50 to 600 keV.

Optionally, the object is a portion of a cargo vehicle that is not occupied by a human being.

Optionally the at least one processor further executes a plurality of programmatic instructions to cause: a low-energy X-ray source to sweep a portion of the cargo vehicle that is occupied by a human being with a low-energy X-ray beam prior to the high-energy X-ray source sweeping the object with the first X-ray beam; and a third set of energy-resolving bins to be generated, wherein each of the third set of energy-resolving bins is defined by an energy range and is configured to receive data indicative of photons detected by the detector assembly as a result of the low-energy X-ray beam interacting with the occupied portion of the cargo vehicle.

Optionally, at least one of a) a number of the third set of energy-resolving bins is different than the number of the first set of energy-resolving bins or the number of the second set of energy-resolving bins and b) one or more of the third set of energy-resolving bins is defined by an energy range that is different than one or more of the energy ranges of the first set of energy-resolving bins or one or more of the energy ranges of the second set of energy-resolving bins.

The present specification discloses an X-ray scanning system, comprising: an X-ray source configured to operate in a first scan mode and a second scan mode, wherein the first scan mode is directed towards scanning a first object using a low-energy X-ray beam, and wherein the second scan mode is directed towards scanning a second object using a high-energy X-ray beam; a detector assembly positioned to receive X-ray photons released from the first object and the second object during the first and second scan modes, respectively; and a processor in data communication with the X-ray radiation source and the detector, wherein the processor executes a plurality of programmatic instructions to: trigger the X-ray source to operate in the first scan mode; implement, in response to the X-ray source scanning the first object in the first scan mode, a first number of energy-resolving bins having associated first number of energy threshold levels; determine, in response to the X-ray source continuing to operate in the first scan mode, a first count of X-ray photons in each of the first number of energy-resolving bins upon being sensed by the detector; trigger the X-ray source to operate in the second scan mode; implement, in response to the X-ray source being triggered to scan the second object in the second scan mode, a second number of energy-resolving bins having associated second number of energy threshold levels; sweep the high-energy X-ray beam once to scan the second object; determine, in response to the sweep, a second count of X-ray photons in each of the second number of energy-resolving bins upon being sensed by the detector; implement, if two or more lower energy-resolving bins of the second number of energy-resolving bins have photon counts of zero, a third number of energy-resolving bins having associated third number of energy threshold levels; and determine, in response to the X-ray source continuing to operate in the second scan mode, a third count of X-ray photons in each of the third number of energy-resolving bins upon being sensed by the detector.

Optionally, the X-ray source is an X-ray tube having energy output ranging from 1 to 600 keV, wherein the low-energy X-ray beam has an end-point energy ranging from 1 to 500 keV while the high-energy X-ray beam has an end-point energy ranging from 50 to 600 keV.

Optionally, the detector assembly has a plurality of detector modules, wherein each of the detector modules has a plurality of fast scintillator crystals optically coupled to photodetectors, and wherein each of the detector modules is electrically coupled to a data acquisition system. Optionally, the fast scintillator crystals are configured to produce optical photons upon receiving X-ray photons, wherein the fast scintillator crystals are of: LYSO, CdZnTe, LSO, CeBr3, GSO, or YAP:Ce material. Optionally, each of the photodetectors is a silicon photomultiplier tube having an array of microcells configured to operate in Geiger-mode and to produce analog electrical signals upon receiving the optical photons. Optionally, the data acquisition system is an ASIC configured to convert the analog electrical signals into digital photon count data, wherein the ASIC has a conversion rate in a range of 1 Mcps to 10 Mcps. Optionally, the conversion rate is about 3 Mcps.

Optionally, the first object is an occupied cab portion of a cargo vehicle and the second object is an unoccupied cargo container portion of the cargo vehicle.

Optionally, each of the first, second and third number of energy-resolving bins is at least 5.

Optionally, the second number of energy-resolving bins and the second number of energy threshold levels are generated by modulating, in real-time, the first number of energy-resolving bins and the first number of energy threshold levels and the third number of energy-resolving bins and the third number of energy threshold levels are generated by modulating, in real-time, the second number of energy-resolving bins and the second number of energy threshold levels. Optionally, each of the second number of energy threshold levels is shifted towards a higher energy compared to the energy of each of the first number of energy threshold levels. Optionally, each of the third number of energy threshold levels is shifted towards a higher energy compared to the energy of each of the second number of energy threshold levels.

Optionally, the plurality of programmatic instructions further determine, in response to the X-ray source continuing to operate in the second scan mode, a continued count of X-ray photons in each of the second number of energy-resolving bins if none of the lower energy-resolving bins of the second number of energy-resolving bins has photon counts of zero.

The present specification also discloses a method of operating an X-ray scanning system having an X-ray source configured to operate in a first scan mode and a second scan mode, wherein the first scan mode is directed towards scanning a first object using a low-energy X-ray beam, and wherein the second scan mode is directed towards scanning a second object using a high-energy X-ray beam and a detector assembly positioned to receive X-ray photons released from the first object and second object during the first scan mode and second scan mode, respectively, the method comprising: triggering the X-ray source to operate in the first scan mode; implementing, in response to the X-ray source scanning the first object in the first scan mode, a first number of energy-resolving bins having associated first number of energy threshold levels; determining, in response to the X-ray source continuing to operate in the first scan mode, a first count of X-ray photons in each of the first number of energy-resolving bins upon being sensed by the detector; triggering the X-ray source to operate in the second scan mode; implementing, in response to the X-ray source being triggered to scan the second object in the second scan mode, a second number of energy-resolving bins having associated second number of energy threshold levels; sweeping, the high-energy X-ray beam, once to scan the second object; determining, in response to the sweep, a second count of X-ray photons in each of the second number of energy-resolving bins upon being sensed by the detector; implementing, if two or more lower energy-resolving bins of the second number of energy-resolving bins have photon counts of zero, a third number of energy-resolving bins having associated third number of energy threshold levels; and determining, in response to the X-ray source continuing to operate in the second scan mode, a third count of X-ray photons in each of the third number of energy-resolving bins upon being sensed by the detector.

The method of claim 13, wherein the X-ray source is an X-ray tube having energy output ranging from 1 to 600 keV, and wherein the low-energy X-ray beam has an end-point energy ranging from 1 to 500 keV while the high-energy X-ray beam has an end-point energy ranging from 50 to 600 keV.

Optionally, the detector assembly has a plurality of detector modules, wherein each of the detector modules has a plurality of fast scintillator crystals optically coupled to photodetectors, and wherein each of the detector modules is electrically coupled to a data acquisition system. Optionally, the fast scintillator crystals are configured to produce optical photons upon receiving X-ray photons, wherein the fast scintillator crystals are of: LYSO, CdZnTe, LSO, CeBr3, GSO, or YAP:Ce material. Optionally, each of the photodetectors is a silicon photomultiplier tube having an array of microcells configured to operate in Geiger-mode and to produce analog electrical signals upon receiving the optical photons. Optionally, the data acquisition system is an ASIC configured to convert the analog electrical signals into digital photon count data, wherein the ASIC has a conversion rate in a range of 1 Mcps to 10 Mcps. Optionally, the conversion rate is about 3 Mcps.

Optionally, the first object is an occupied cab portion of a cargo vehicle and the second object is an unoccupied cargo container portion of the cargo vehicle.

Optionally, each of the first, second and third number of energy-resolving bins is at least 5.

Optionally, the second number of energy-resolving bins and the second number of energy threshold levels are generated by modulating, in real-time, the first number of energy-resolving bins and the first number of energy threshold levels and the third number of energy-resolving bins and the third number of energy threshold levels are generated by modulating, in real-time, the second number of energy-resolving bins and the second number of energy threshold levels. Optionally, each of the second number of energy threshold levels is shifted towards a higher energy compared to the energy of each of the first number of energy threshold levels. Optionally, each of the third number of energy threshold levels is shifted towards a higher energy compared to the energy of each of the second number of energy threshold levels.

Optionally, the method further comprises determining, in response to the X-ray source continuing to operate in the second scan mode, a continued count of X-ray photons in each of the second number of energy-resolving bins if none of the lower energy-resolving bins of the second number of energy-resolving bins has photon counts of zero.

The present specification further discloses an X-ray scanning system, comprising: an X-ray source configured to direct a high-energy X-ray beam to scan an object; a detector assembly positioned to receive X-ray photons released from the object; and a processor in data communication with the X-ray radiation source and the detector, wherein the processor executes a plurality of programmatic instructions to: trigger the X-ray source to generate the high-energy X-ray beam; implement, in response to the X-ray source being triggered to generate the high-energy X-ray beam, a first number of energy-resolving bins having associated first number of energy threshold levels; sweep the high-energy X-ray beam once to scan the second object; determine, in response to the sweep, a first count of X-ray photons in each of the first number of energy-resolving bins upon being sensed by the detector; implement, if two or more lower energy-resolving bins of the first number of energy-resolving bins have photon counts of zero, a second number of energy-resolving bins having associated second number of energy threshold levels; and determine, in response to the X-ray source continuing to sweep the high-energy X-ray beam, a second count of X-ray photons in each of the second number of energy-resolving bins upon being sensed by the detector.

Optionally, the X-ray source is an X-ray tube having energy output ranging from 1 to 600 keV, wherein the high-energy X-ray beam has an end-point energy ranging from 50 to 600 keV.

Optionally, the detector assembly has a plurality of detector modules, wherein each of the detector modules has a plurality of fast scintillator crystals optically coupled to photodetectors, and wherein each of the detector modules is electrically coupled to a data acquisition system. Optionally, the fast scintillator crystals are configured to produce optical photons upon receiving X-ray photons, wherein the fast scintillator crystals are of: LYSO, CdZnTe, LSO, CeBr3, GSO, or YAP:Ce material. Optionally, each of the photodetectors is a silicon photomultiplier tube having an array of microcells configured to operate in Geiger-mode and to produce analog electrical signals upon receiving the optical photons. Optionally, the data acquisition system is an ASIC configured to convert the analog electrical signals into digital photon count data, wherein the ASIC has a conversion rate in a range of 1 Mcps to 10 Mcps. Optionally, the conversion rate is of about 3 Mcps.

Optionally, each of the first and second number of energy-resolving bins is at least 5.

Optionally, the second number of energy-resolving bins and the second number of energy threshold levels are generated by modulating, in real-time, the first number of energy-resolving bins and the first number of energy threshold levels. Optionally, each of the second number of energy threshold levels is shifted towards a higher energy compared to the energy of each of the first number of energy threshold levels.

Optionally, the plurality of programmatic instructions further determines, in response to the X-ray source continuing to sweep the high-energy X-ray beam, a third count of X-ray photons in each of the first number of energy-resolving bins if none of the lower energy-resolving bins of the first number of energy-resolving bins has photon counts of zero.

The present specification also discloses a method of operating an X-ray scanning system having an X-ray source configured to direct a high-energy X-ray beam to scan an object and a detector assembly positioned to receive X-ray photons released from the object, the method comprising: triggering the X-ray source to generate the high-energy X-ray beam; implementing, in response to the X-ray source being triggered to generate the high-energy X-ray beam, a first number of energy-resolving bins having associated first number of energy threshold levels; sweeping, the high-energy X-ray beam, once to scan the second object; determining, in response to the sweep, a first count of X-ray photons in each of the first number of energy-resolving bins upon being sensed by the detector; implementing, if two or more lower energy-resolving bins of the first number of energy-resolving bins have photon counts of zero, a second number of energy-resolving bins having associated second number of energy threshold levels; and determining, in response to the X-ray source continuing to sweep the high-energy X-ray beam, a second count of X-ray photons in each of the second number of energy-resolving bins upon being sensed by the detector.

Optionally, the X-ray source is an X-ray tube having energy output ranging from 1 to 600 keV, wherein the high-energy X-ray beam has an end-point energy ranging from 50 to 600 keV.

Optionally, the detector assembly has a plurality of detector modules, wherein each of the detector modules has a plurality of fast scintillator crystals optically coupled to photodetectors, and wherein each of the detector modules is electrically coupled to a data acquisition system. Optionally, the fast scintillator crystals are configured to produce optical photons upon receiving X-ray photons, wherein the fast scintillator crystals are of: LYSO, CdZnTe, LSO, CeBr3, GSO, or YAP:Ce material. Optionally, each of the photodetectors is a silicon photomultiplier tube having an array of microcells configured to operate in Geiger-mode and to produce analog electrical signals upon receiving the optical photons. Optionally, the data acquisition system is an ASIC configured to convert the analog electrical signals into digital photon count data, wherein the ASIC has a conversion rate in a range of 1 Mcps to 10 Mcps. Optionally, the conversion rate is of about 3 Mcps.

Optionally, each of the first and second number of energy-resolving bins is at least 5.

Optionally, the second number of energy-resolving bins and the second number of energy threshold levels are generated by modulating, in real-time, the first number of energy-resolving bins and the first number of energy threshold levels. Optionally, each of the second number of energy threshold levels is shifted towards a higher energy compared to the energy of each of the first number of energy threshold levels.

Optionally, the method further comprises determining, in response to the X-ray source continuing to sweep the high-energy X-ray beam, a third count of X-ray photons in each of the first number of energy-resolving bins if none of the lower energy-resolving bins of the first number of energy-resolving bins has photon counts of zero.

The aforementioned and other embodiments of the present specification shall be described in greater depth in the drawings and detailed description provided below.

### BRIEF DESCRIPTION OF THE DRAWINGS

The accompanying drawings illustrate various embodiments of systems, methods, and embodiments of various other aspects of the disclosure. Any person with ordinary skill in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1A is a schematic diagram showing conventional dual-energy scanning modes;

FIG. 1B is an exemplary X-ray image generated using a dual-energy scanning mode with multiple, stacked detectors;

FIG. 1C is a schematic diagram showing additional conventional multi-energy scanning concepts;

FIG. 2 is a block diagram showing a scanning environment, in accordance with some embodiments of the present specification;

FIG. 3 is a graph showing a plurality of detected pulses that are resolved using a first number of bins, a second number of bins, and a third number of bins, in accordance with some embodiments of the present specification;

FIG. 4 shows a first plot of a plurality of detected pulses resolved using a first threshold energy level and a second plot of a plurality of detected pulses resolved using a second energy threshold level, in accordance with some embodiments of the present specification;

FIG. 5 is a flowchart showing a plurality of steps of a first method for improving energy resolving capabilities of the photon-counting detector (PCD) of the X-ray scanning system, in accordance with some embodiments of the present specification; and

FIG. 6 is a flowchart showing a plurality of steps of a second method for improving energy resolving capabilities of the photon-counting detector (PCD) of the X-ray scanning system, in accordance with some embodiments of the present specification.

### DETAILED DESCRIPTION

The present specification is directed towards multiple embodiments. The following disclosure is provided in order to enable a person having ordinary skill in the art to practice the invention. Language used in this specification should not be interpreted as a general disavowal of any one specific embodiment or used to limit the claims beyond the meaning of the terms used therein. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

In various embodiments, a computing device includes an input/output controller, at least one communications interface and system memory. The system memory includes at least one random access memory (RAM) and at least one read-only memory (ROM). These elements are in communication with a central processing unit (CPU) to enable operation of the computing device. In various embodiments, the computing device may be a conventional standalone computer or alternatively, the functions of the computing device may be distributed across multiple computer systems and architectures.

In some embodiments, execution of a plurality of sequences of programmatic instructions or code enable or cause the CPU of the computing device to perform various functions and processes. In alternate embodiments, hard-wired circuitry may be used in place of, or in combination with, software instructions for implementation of the processes of systems and methods described in this application. Thus, the systems and methods described are not limited to any specific combination of hardware and software.

It should be noted that each component, processor, scanning system, and/or device described herein is configured to perform the functions and communications described herein. It should further be appreciated that each device and monitoring system have wireless and wired receivers and transmitters capable of sending and transmitting data, at least one processor capable of processing programmatic instructions, memory capable of storing programmatic instructions, and software comprised of a plurality of programmatic instructions for performing the processes described herein.

The term “module” or “engine” used in this disclosure may refer to computer logic utilized to provide a desired functionality, service or operation by programming or controlling a general purpose processor. Stated differently, in some embodiments, a module or engine implements a plurality of instructions or programmatic code to cause a general purpose processor to perform one or more functions. In various embodiments, a module or engine can be implemented in hardware, firmware, software or any combination thereof. The module or engine may be interchangeably used with unit, logic, logical block, component, or circuit, for example. The module or engine may be the minimum unit, or part thereof, which performs one or more particular functions.

In the description and claims of the application, each of the words “comprise”, “include”, “have”, “contain”, and forms thereof, are not necessarily limited to members in a list with which the words may be associated. Thus, they are intended to be equivalent in meaning and be open-ended in that an item or items following any one of these words is not meant to be an exhaustive listing of such item or items, or meant to be limited to only the listed item or items. It should be noted herein that any feature or component described in association with a specific embodiment may be used and implemented with any other embodiment unless clearly indicated otherwise.

It must also be noted that as used herein and in the appended claims, the singular forms “a,” “an,” and “the” include plural references unless the context dictates otherwise. Although any systems and methods similar or equivalent to those described herein can be used in the practice or testing of embodiments of the present disclosure, the preferred, systems and methods are now described.

### Overview

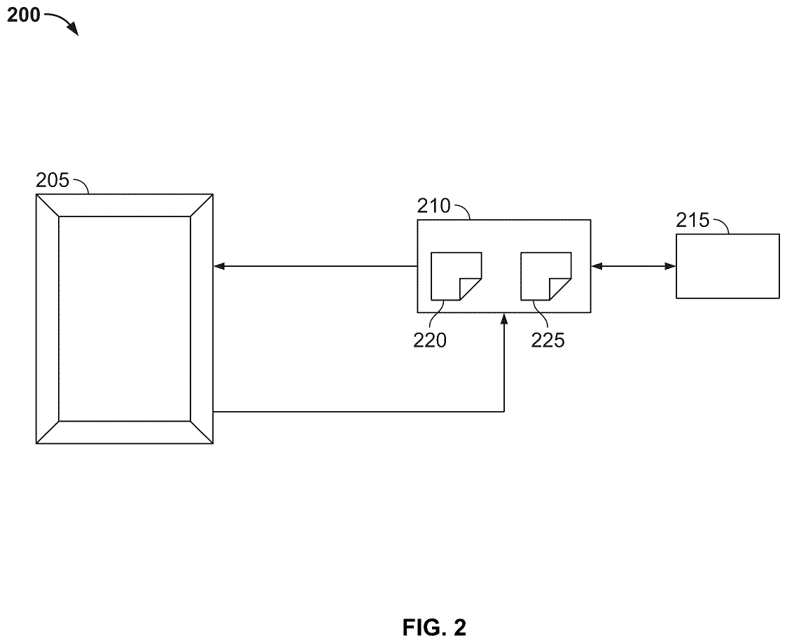

FIG. 2 is a block diagram illustration of a scanning environment 200, in accordance with some embodiments of the present specification. In embodiments, scanning environment 200 comprises an X-ray scanning system 205 having at least one X-ray source and at least one detector assembly with at least one photon-counting detector (PCD). The at least one X-ray source is configured to direct an X-ray beam onto a target object while the at least one PCD is configured to generate scan data corresponding to the received and detected X-ray photons released from the target object. The scan data is, in turn, received and processed by a processor 210. Processor 210 is in data communication with X-ray scanning system 205. Processor 210 is configured to perform energy-discrimination of the scan data to enable material classification and generate at least one processed X-ray image of the target object. The results of material classification along with the processed X-ray image is communicated to at least one user computing device 215 for display on an associated display or monitor. It should be noted herein that, in some embodiments, the systems and methods of the present specification can be used with certain flying spot transmission systems that include multi-energy sources and/or the use of photon counting detectors. By way of example, and in no way construed to be limiting, the systems and methods of the present specification may be employed across all transmission and/or backscatter implementations, including, but not limited to the lower energy handheld backscatter systems that are used in conjunction with a transmission detector. In the lower energy handheld configuration, the energy range of interest would be captured with the use of an X-ray tube having an energy output ranging from 50 to 600 keV.

In some embodiments, the at least one X-ray source is an X-ray tube that is configured to generate a continuous beam of X-rays. In various embodiments, the X-ray tube has an energy output ranging from 50 keV to 600 keV.

In some embodiments, the target object includes cargo containers, vehicles, including passenger vehicles, trains, and pallets.

In some embodiments, the at least one PCD includes a plurality of detector modules and associated data acquisition systems. Each of the plurality of detector modules includes a plurality of detector elements or pixels arranged in ‘n’ rows and ‘m’ columns. Each detector element or pixel has a scintillator component or scintillator-based detection stage and a light sensor component or light sensor-based detection stage connected to or integrated into an integrated circuit. The ‘fast’ scintillator-based detection stage receives impinging X-ray photons released from the target object and in response generates corresponding light photons. The light photons traverse the scintillator-based detection stage and are received by the light sensor-based or ‘fast’ optical conversion detection stage which converts the light photons into analog electrical signals. The generated analog signals are carried to a coupled data acquisition stage where the analog signals are converted to a digital signal. Each stage is described in greater detail below.

In accordance with some aspects of the present specification, the scintillator component is fabricated using a ‘fast’ scintillator crystal material, such as, but not limited to, LYSO, CdZnTe, LSO, CeBr3, GSO, and YAP:Ce. The scintillator-based detection stage is characterized by a rapid decay time of the photons generated within the scintillator component, whereby the rapid decay time is on the order of 0.01 to 100 nanoseconds.

In accordance with further aspects of the present specification, the light sensor component or light-sensor based detection stage is a ‘fast’ optical conversion stage that is capable of providing individual X-ray photon identification at a rate that resides below the X-ray interaction frequency within the scintillator. In some embodiments, for a scintillator-sensitive area of around 5×5 mm²/channel, the maximum count rate is about 0.12 Mcps/mm².

In some embodiments, the ‘fast’ optical conversion stage includes a SiPM (Silicon Photo-Multiplier) instead of a photodiode. SiPMs operate based on the Geiger-mode avalanche photodiode principle. They consist of an array of tiny silicon microcells connected in parallel. Each microcell can operate in Geiger mode, meaning it can undergo a rapid avalanche multiplication of charge carriers when a photon is detected. It is the rapid nature of this multiplication stage that results in a far faster response time than the photodiode. On the other hand, photodiodes operate in a linear mode. When a photon is absorbed, it generates an electron-hole pair, and the generated photocurrent is directly proportional to the incident light intensity. Photodiodes do not exhibit the avalanche multiplication effect seen in SiPMs.

The bias voltage applied to SiPMs is on the order of 5 V to 15 V, which is typically higher than that used for traditional photodiodes and is adjusted to a level where individual microcells can operate in Geiger mode. The bias voltage is set to a level just above the breakdown voltage, where the avalanche multiplication occurs. In embodiments, the breakdown voltage value is the voltage at which the multiplication factor (the number of secondary carriers produced per primary carrier (electron)) diverges, which is different than the linear response one would see with a photodiode. It is this higher bias that creates the larger multiplication at the same time, making the SiPMs simultaneously more sensitive to smaller signals. As a result, SiPMs are capable of detecting single photons because when a single photon is absorbed, it triggers an avalanche effect in one or more microcells, resulting in a measurable signal. Photodiodes typically require higher light intensities to generate a measurable photocurrent and are, therefore, less sensitive to single photons compared to SiPMs.

In accordance with still further aspects of the present specification, the data acquisition system includes a dedicated ASIC (application-specific integrated circuit) for digital conversion. In some embodiments, the ASIC is configured to perform photon counting at a digital conversion rate typically ranging from 1-20 Mcps, and preferably 3 Mcps (mega counts per second), which is relatively high when compared with photodiodes.

Overall, in accordance with various aspects, in addition to enhanced performance, the systems and methods of the present specification have the benefit of providing a lower footprint and detector envelope because the requirement for only one crystal, one SiPM, and one PCB reduces the overall dimension of a solution when compared to using the conventional footprint of having two of each. Another benefit is reduced costs as compared to the multiple data acquisition systems that would be required for conventional dual crystal configurations. And yet another advantage would be that one crystal, even if larger in dimension than the crystals currently used, would be less costly, as there is less machining required to manufacture, fewer cuts, less waste, and higher yield.

It should be understood by those of ordinary skill in the art that the X-ray scanning system 105 may, in various embodiments, include any ionizing radiation-based imaging modality such as, but not limited to, a radiography system, a CT (Computed Tomography) system, a Real-time Tomography (RTT) or stationary gantry system, or a PET (Positron Emission Tomography) system. It should be appreciated that while various aspects of the present specification have been described with reference to an X-ray based scanning or imaging device, these aspects are equally applicable to other ionizing radiation-based imaging systems such as, for example, gamma radiation based systems.

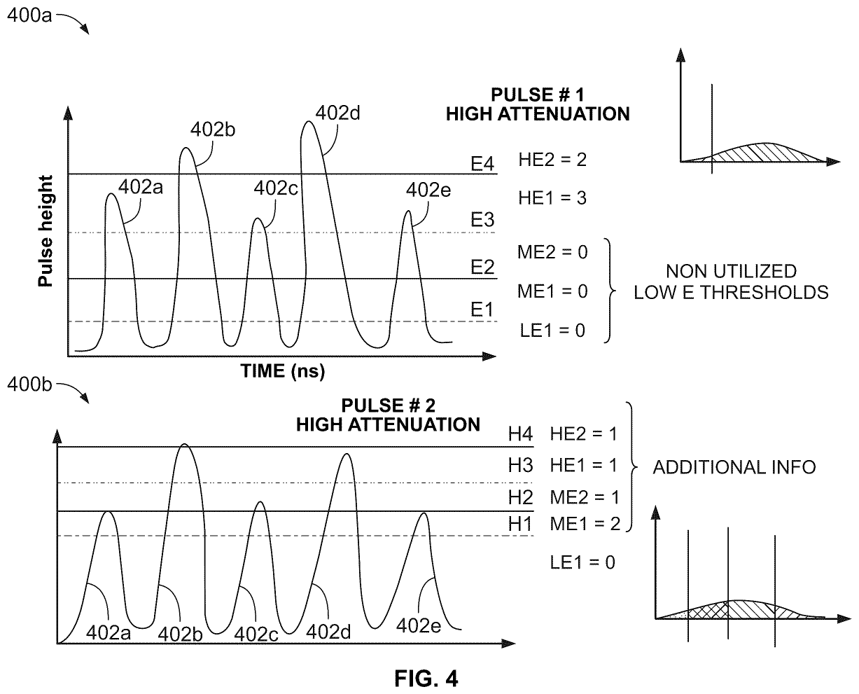

In embodiments, the processor 210 is configured to implement an adaptive binning (AB) module or engine 225 configured to, dynamically and in real-time, implement and/or modulate one or more binning schemes. The modulation binning is, in embodiments, managed by the data acquisition electronics within processor 210, where the data acquisition electronics is in data communication with a controller associated with and configured to control system 205. Thus, when the controller of system 205 triggers the X-ray source to operate in a different energy mode, the same trigger signal is also transmitted to and/or received by the electronics managing the data acquisition within processor 210. The processor 210 then sends a command to the analog-to-digital processing ASIC which is configured to adjust the thresholds for energy binning accordingly. The trigger signal is typically a digital IO (input/output), and in embodiments the trigger signal is communicated through Modbus, CAN Bus, TCP/IP, Ethernet/IP, wireless or serial communication. The implementation of AB is in real time, and requires a line-by-line measurement of the signal in each bin, in order to adjust the thresholds ahead of the next (n) line. The ASIC implements the AB analysis described in the present specification, performing energy bin adjustments at the individual detector level. This localized approach allows dynamic adaptation to high-attenuation regions within specific portions of a line scan. Preconfigured intensity thresholds within the ASIC determine the required bin value adjustments. These are illustrated and explained further in FIG. 4. The terms dynamic, real-time, or on-the-fly refers to conducting, or engaging in, two or more processes concurrently, or substantially concurrently (that is, with no meaningful delay between the start of one process and the termination of a second process), in time.

In embodiments, the processor 210 is also configured to implement at least one module or engine 220, which in turn, is configured for performing tasks such as, for example, scan data estimation, image reconstruction and correction. It should be appreciated that the functions of scan data estimation, image reconstruction and correction may either be integrated into a single module or engine (such as the module or engine 220) or, alternatively, may be distributed in multiple modules or engines. The processor 210 is also configured to receive user input from the computing device 215. In some embodiments, processor 210 comprises more than one processing system.

### Adaptive Binning (AB) Module 225

In accordance with aspects of the present specification, the AB module 225 includes a plurality of instructions or programmatic code which, when executed, implement a binning scheme comprising ‘N’ number of energy-discrimination bins associated with ‘N−1’ energy threshold levels—such that a) the number of bins ‘N’ and b) each of the ‘N−1’ energy threshold levels are on-the-fly modulated (that is, in real-time) based upon first and/or second scan characteristics.

### Higher Number of Bins

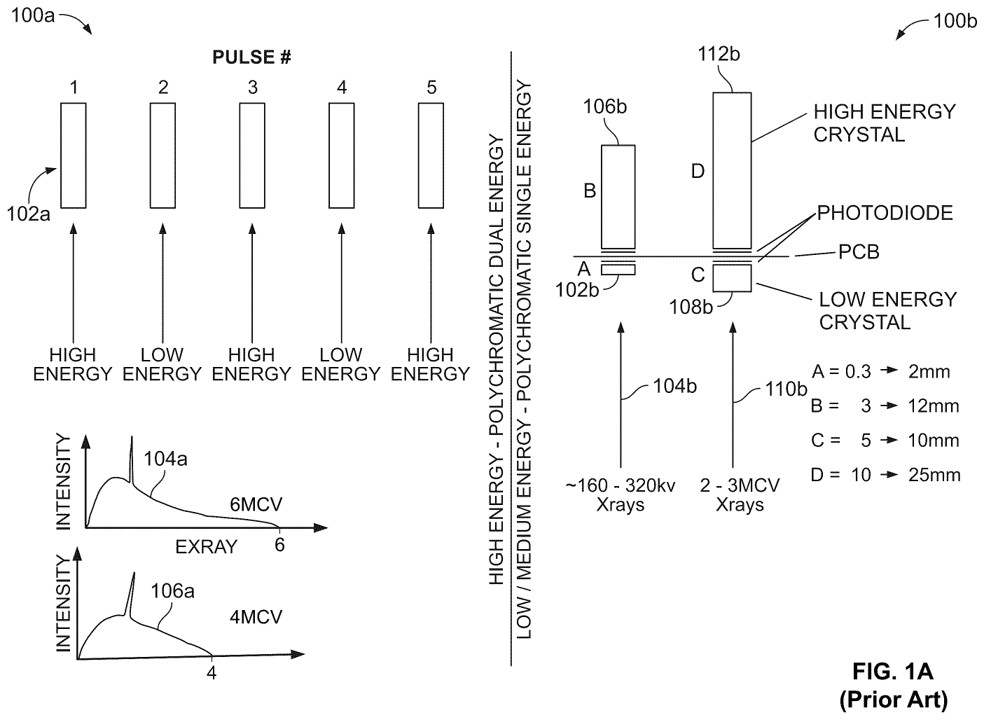

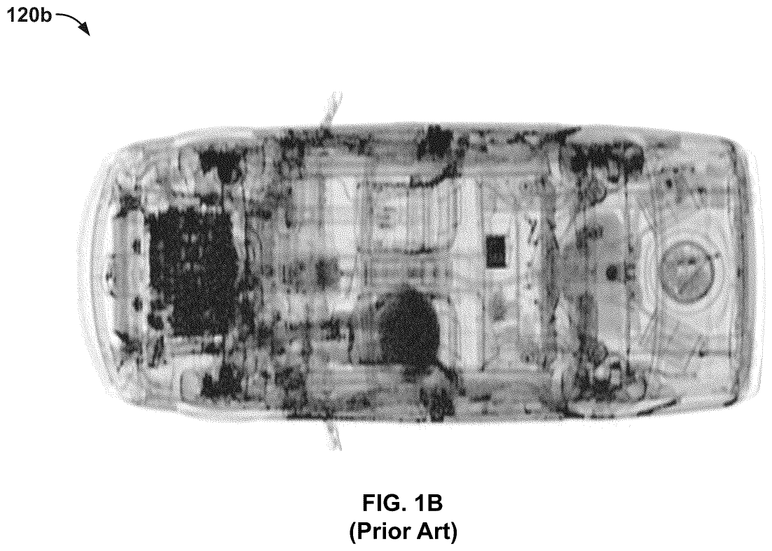

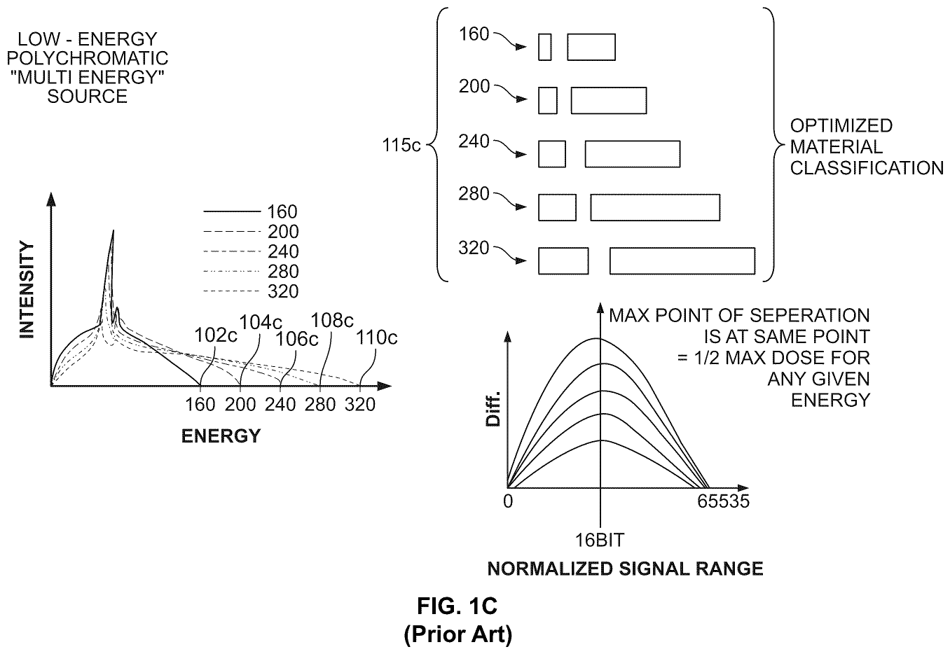

Conventional X-ray systems operate with three levels of material classification, which is based on the use of a simple two-level binning method. The number of material classification levels does not correlate to the number of bins, but instead the quality of the data captured. Referring to the limitations described with FIGS. 1A and 1B, the existing techniques do not provide a true separation of energies but instead provide an “average” energy separation. Some high-energy X-rays interact in the front, low energy crystal. It is desirable to get closer to measuring the exact energy of the interacting X-rays, which is achieved by accurately determining the atomic number of each attenuating material. In embodiments, methods of the present specification provide a relatively more accurate measurement of the individual X-ray interaction energies, which may offer an enhanced level of discrimination. In some embodiments, four to ten levels of material classification is achieved.

In various embodiments, the total number of bins ‘N’ is at least 5, resulting in at least 4 (that is, N−1) corresponding energy thresholds. The higher the number of bins ‘N’, where ‘N’ is at least 5, enables more layers of material separation, which has the potential to add a level of enhanced organic separation between hydrogenous and carbon-based organics. Also, the higher the number of bins ‘N’ promotes rejection of low-energy scatter signal that corrupts the transmission data and reduces material separation confidence. In some embodiments, the number of bins ‘N’ is modulated, on-the-fly, in order to a) promote rejection of a low-energy scatter signal that corrupts the transmission data and reduces material separation confidence and b) enable enhanced material separation.

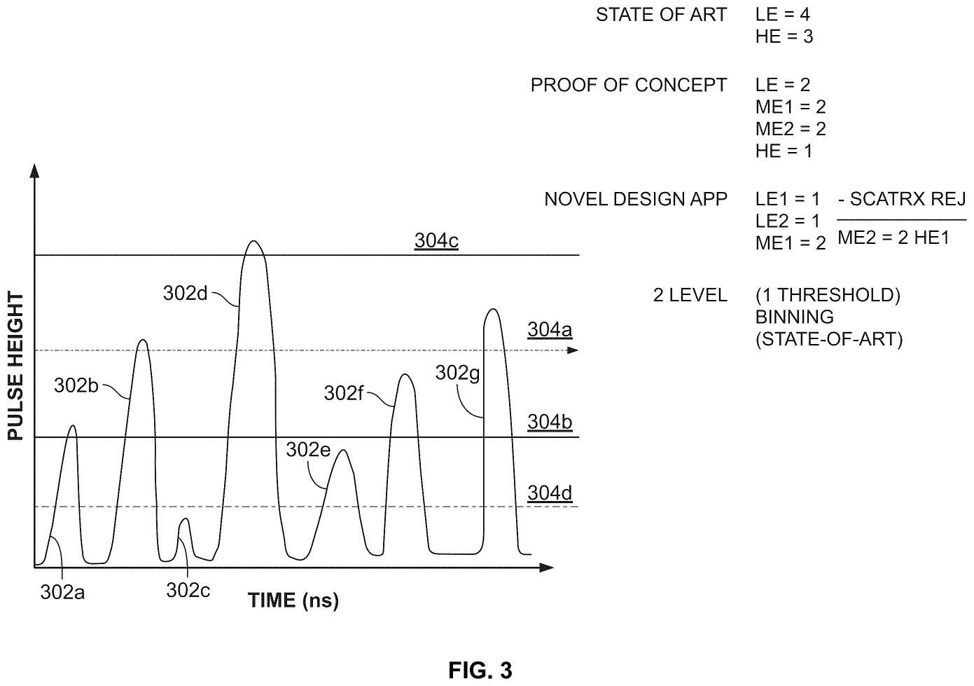

FIG. 3 is a graph showing a plurality of detected pulses that are resolved using a first number of bins, a second number of bins, and a third number of bins, in accordance with some embodiments of the present specification. As shown, the plurality of pulses 302a through to 302g are plotted with a pulse height on the Y-axis and a time duration on the X-axis. With only one energy threshold level 304a, the first number of bins corresponds to two bins-a high-energy bin and a low-energy bin. The low-energy bin has 4 counts (corresponding to pulses 302a, 302c, 302e and 302f) and the high-energy bin has 3 counts (corresponding to pulses 302b, 302d and 302g).

With three energy threshold levels 304a, 304b and 304c, the second number of bins corresponds to four bins. Here, the low-energy bin has 2 counts (corresponding to pulses 302c and 302e), a first medium-energy bin has 2 counts (corresponding to pulses 302a and 302f), a second medium-energy bin has 2 counts (corresponding to pulses 302b and 302g) and a high-energy bin has 1 count (corresponding to pulse 302d).

With four energy threshold levels 304a, 304b, 304c and 304d, the third number of bins corresponds to five bins. This includes a first low-energy bin that has 1 count (corresponding to pulse 302c), a second low-energy bin that has 1 count (corresponding to pulse 302e), a first medium-energy bin that has 2 counts (corresponding to pulses 302a and 302f), a second medium-energy bin that has 2 counts (corresponding to pulses 302b and 302g) and a high-energy bin that has 1 count (corresponding to pulse 302d).

The third (higher) number of bins, which corresponds to five bins, affords additional material discrimination capability and, therefore, rejection of the low-energy signals corresponding to pulse 302c that corrupts the detected X-ray photon data and reduces material separation confidence. Additionally, the third (higher) number of bins (at least five bins) enables more layers of material discrimination. Generally, it should be noted that even in the absence of an object under inspection attenuating the beam, there is a minimum X-ray energy that will be detected at the array, as a result of source filtration, air scatter, and attenuation through the system structure. Therefore, extremely low-energy photons that are measured in the process of imaging a vehicle must result from scattering and will act to corrupt the transmission of un-scattered data.

### Scan Conveyances

In embodiments, the energy threshold levels are dynamically modulated in order to provide for an optimal distribution of energy-discriminating bins within the range of X-ray photons reaching the PCDs (photon-counting detectors).

In some embodiments, the first scan characteristic corresponds to scan conveyances, which refer to the relatively high or low attenuating effects of scanned objects. In embodiments, with an ‘N’ number of bins, the ‘N−1’ energy threshold levels are dynamically modulated depending upon the attenuating effect of a scanned object. For example, scanning of high attenuating objects, which remove large portions of the low-energy spectral composition of a sweeping X-ray beam, benefit from on-the-fly shifting of threshold levels or boundaries to higher energies for separation in the relevant region when imaging. Similarly, as an example, scanning of low attenuating objects benefit from equitable distribution of threshold levels or boundaries across the range of X-ray photons reaching the PCDs.

The following examples illustrate several scenarios where signal levels in certain bins are zero, or below a threshold, which may prompt a shift to other bins. It should be noted that the trigger to shift the bins is not necessarily the absence of a signal or a signal of zero, or even a signal below a threshold. The trigger may result in real time from any combination of any of the bins (any of the five bins, specifically in the embodiments described herein) which are indicative of signals below a threshold. The trigger also results in a change in the values of the thresholds for binning. Similarly a large signal in a low energy bin (for example LE1 and ME1 of FIG. 4) may suggest little to no attenuation and therefore results in an adjustment of the thresholds to lower energy values to provide better granularity at the low-energy level. Further, the trigger is based on the value of signals in the bins, which is variable. The value is based on electronic noise, which establishes a baseline minimum. Above this baseline, there is typically a signal component from X-ray interactions that result in partial, rather than full, energy deposition. This partial signal is usually accounted for by calculations involving Compton scatter events, for example. The resulting value is then compared to a threshold or expressed as a percentage of the total signal, and it is less than this specified limit.

FIG. 4 shows first a first plot 400a and a second plot 400b of a plurality of detected pulses resolved using a first energy threshold level and second energy threshold level, respectively, in accordance with some embodiments of the present specification. The first plot 400a and second plot 400b show a plurality of pulses 402a through to 402e with pulse height on the Y-axis and time duration on the X-axis. The energies of the plurality of pulses 402a through to 402e are indicative of scanning of a high attenuation object since the energies of the plurality of pulses 402a through to 402e are devoid of portions of the low-energy spectral composition of the sweeping X-ray beam. As an example, in the first plot 400a, the plurality of pulses is separated using five bins demarcated by the first energy threshold levels E1, E2, E3 and E4. The four energy threshold levels E1 through to E4 are approximately equally distributed across the range of energies of the plurality of detected pulses 402a through to 402e, where in some embodiments, the range of energies is between 25 keV and 500 keV. Consequently, a low-energy bin has a count of zero (since none of the plurality of pulses 402a through to 402e has energy lying within the corresponding energy threshold level E1), a first medium-energy bin has a count of zero (since none of the plurality of pulses 402a through to 402e has energy lying within the energy threshold level ranging from E1 to E2), a second medium-energy bin also has count of zero (since none of the plurality of pulses 402a through to 402e has energy lying within the energy threshold level ranging from E2 to E3), a first high-energy bin has a count of 3 (since pulses 402a, 402c and 402e have energies lying within the energy threshold level ranging from E3 to E4) and a second high-energy bin has a count of 2 (since pulses 402b and 402d have energies lying beyond the energy threshold level E4). Thus, this first distribution of the four energy threshold levels E1 through to E4 is sub-optimal for energy separation of the detected plurality of pulses 402a through to 402e. In some scenarios, energy bins on an extreme side of a spectrum (such as towards the lower energy levels or towards the higher energy levels), have bin counts of less than another threshold level ‘T’, where bin counts of ≤T results in modulation of the energy threshold levels. In the illustrated example of plot 400A, T=0. In other exemplary scenarios, T=1, or T=2, or any other number or increment therein. Referring to the scenario illustrated in FIG. 3, pulse 302c in the lowest energy bin is discarded when T=1.

The second plot 400b shows the second energy threshold levels H1 through to H4 that have been modulated to higher energies compared to the energy threshold levels E1 through to E4. Consequently, a low-energy bin has a count of zero, which is illustrated in plot 400b as seen below H1 energy threshold level (since none of the plurality of pulses 402a through to 402e has energy lying within the corresponding energy threshold level H1), a first medium-energy bin has 2 counts (since pulses 402a and 402e have energies lying within the energy threshold level ranging from H1 to H2), a second medium-energy bin has 1 count (since pulse 402c has energy that lies within the energy threshold level ranging from H2 to H3), a first high-energy bin has 1 count (since pulse 402d has energy lying within the energy threshold level ranging from H3 to H4) and a second high-energy bin has 1 count (since pulse 402b has energy lying beyond the energy threshold level H4). Thus, this second distribution of the four energy threshold levels H1 through to H4 is optimal for energy separation of the detected plurality of pulses 402a through to 402e.

It should be noted that in the above example, while energy threshold levels E1 to E4 are termed as ‘low’ and energy threshold levels H1 to H4 are termed as ‘high’, the terms ‘low’ and ‘high’ are only relative to each other, since the former has threshold levels (such as E1, E2, E3, E4) at a lower value compared to the threshold levels (H1, H2, H3, H4) of the latter.

### Scan Modes

In some embodiments, the scan characteristic corresponds to scan modes which are based on different X-ray source energy outputs. In embodiments, given an ‘N’ number of bins, the ‘N−1’ energy threshold levels are dynamically modulated for optimum energy separation depending upon the scanning CONOPs (Concept of Operations), which may vary from high-throughput, low-dose occupied primary inspection to high-dose unoccupied secondary inspection.

For example, in an embodiment the X-ray scanning system 205 is configured to operate in a first scan mode where the X-ray source generates a low-energy X-ray beam (corresponding to the X-ray source energy output of, say, 160 keV) and a second scan mode where the X-ray source generates a high-energy X-ray beam (corresponding to the X-ray source energy output of, for example, 320 keV). In a first exemplary scenario, the X-ray scanning system 205 may be configured to scan a cargo vehicle having a cab portion followed by a cargo-container portion. The cab portion may be occupied (such as, by a driver) and hence when the cab portion enters the scanning region, the system 200 is triggered to operate in the first scan mode (of generating the low-energy X-ray beam). The cargo-container portion does not have occupants and hence when the cargo-container portion enters the scanning region, the system 200 is triggered to operate in the second scan mode (of generating the high-energy X-ray beam).

In a second exemplary scenario, the system may be configured to perform a primary inspection of a vehicle in the first scan mode (generating the low-energy X-ray beam) without requiring the occupants of the vehicle to exit. If the primary inspection raises an alarm, a second inspection of the vehicle may be conducted in the second scan mode (generating the high-energy X-ray beam) after the occupants of the vehicle leave the vehicle.

The present specification provides for dynamic on-the-fly modulation of the ‘N’ number of energy-discrimination bins and/or the associated ‘N−1’ energy threshold levels in response to both the first scan mode and second scan mode—that is, the different X-ray source energy outputs. Thus, the systems and methods of the present specification support the ability to modulate the bins based on a real-time measurement in both scan modes (occupied and unoccupied and low-energy and high-energy). For example, in either mode, it may be seen that the first pulse and/or first data capture window and/or first sweep of the source result in no signal in the first bin, based on an even distribution of bins across the full range. In this case, for the second data capture window (or even third if there is processing time to account for), shifting the bins to higher energies will allow for better separation in the correct region of signal.

As a non-limiting example, for scanning using different source output energies, a solution/approach may be to set the energy threshold levels at approximately equal energy increments between the minimum and maximum source energy outputs. On sensing an occupied cab portion of a cargo vehicle, the X-ray scanning system 205 is triggered to operate in the first scan mode with a source output energy of 160 keV as a result of which the AB module 225 is configured to automatically implement a first binning scheme of N=6 bins and N−1=5 energy threshold levels. The 5 threshold levels would be at, for example, ˜ 27 keV, 54 keV, 81 keV, 108 keV and 135 keV. However, on sensing an unoccupied cargo portion, the X-ray scanning system 205 is triggered to operate in the second scan mode with a source output energy of 320 keV as a result of which the AB module 225 is configured to automatically modulate and implement a second binning scheme of N=7 bins and N−1=6 energy threshold levels. The 6 threshold levels would be at, for example, ˜ 53 keV, 106 keV, 159 keV, 213 keV, 266 keV and 319 keV. It should be noted that, even though the energy levels included in the first binning scheme of the first scan mode and the second binning scheme corresponding to the second scan mode overlap, modulation to the second binning scheme enables optimal detection leading to generation of sufficient information on the materials of the high-density cargo portion while the first binning scheme enables optimal detection leading to generation of sufficient information on the relatively low-density areas of the cab portion while maintaining a safe radiation exposure profile for the occupied section of the cargo vehicle. It should be appreciated that other solutions/approaches of setting the energy threshold levels may examine where the largest source of scatter comes from to target the lowest threshold level to account for this.

Now consider a scenario where, after one sweep of the high-energy X-ray beam at the source output energy of 320 keV, the photon counts measured are zero (or ≤T, where T≥1) in the <53 keV, <106 keV and <159 keV bins (of the second binning scheme). This is indicative of sufficient absorption in the beam (perhaps due to high attenuating effect of the object being scanned) such that the <53 keV, <106 keV and <159 keV bins are of no use. Consequently, the AB module 225 is configured to automatically implement a third binning scheme that shifts energy threshold levels, of the second binning scheme, before the next pulse to between 159 keV and 320 keV while reducing the number of bins to 6. Thus, in the third binning scheme there are N=6 bins and N−1=5 energy threshold levels that are skewed to higher energy levels of 159 keV, 191 keV, 223 keV, 255 keV and 288 keV. It should be noted that the third binning scheme enables detection and generation of far more information on the materials of the scanned object compared to the second binning scheme.

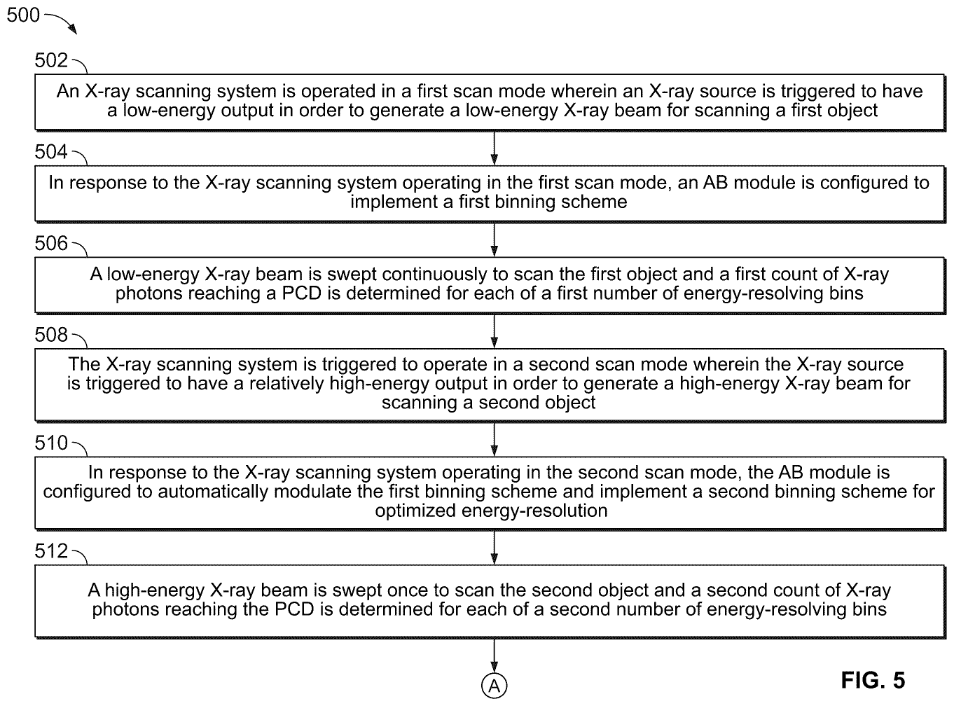

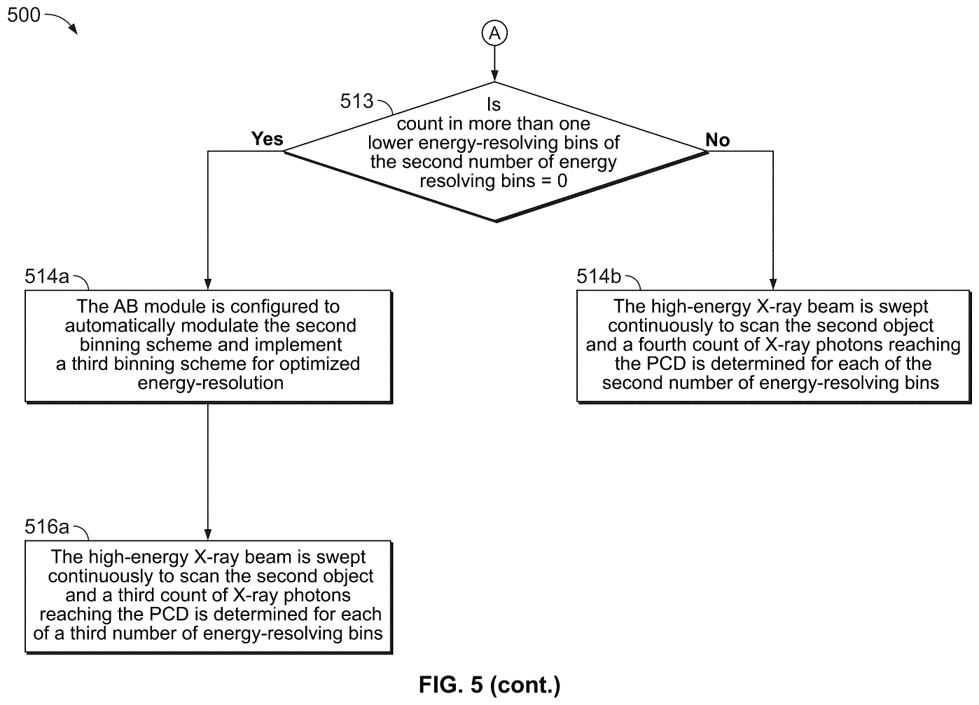

FIG. 5 is a flowchart detailing a plurality of steps of a method 500 for improved energy resolving capabilities of the photon-counting detector (PCD) of the X-ray scanning system 105, in accordance with some embodiments of the present specification. In some embodiments, the processor 210 is configured to execute the steps of method 500.

Referring now to FIGS. 2 and 5, at step 502, the X-ray scanning system 205 is operated in a first scan mode wherein the X-ray source is triggered to have a low-energy output in order to generate a low-energy X-ray beam for scanning a first object. In some embodiments, the low-energy output ranges from 1 keV to 200 keV. In some embodiments, the low-energy X-ray beam has an end-point energy ranging from 1 keV to 500 keV.

At step 504, in response to the X-ray scanning system 205 operating in the first scan mode, the AB module 225 is configured to implement a first binning scheme for energy-resolution. The first binning scheme includes a first number of energy-resolving bins having associated therewith a first number of energy threshold levels, wherein the first number of energy threshold levels is 1 less than the first number of energy-resolving bins. In some embodiments, the first number of energy-resolving bins is at least 5. In some embodiments, the first number of energy threshold levels have approximately equal energy increments between the minimum and maximum source energy outputs.

At step 506, the low-energy X-ray beam is swept continuously to scan the first object and a first count of X-ray photons reaching the PCD is determined for each of the first number of energy-resolving bins. The count of X-ray photons is performed based on a comparison of an energy of an X-ray photon and the energy intervals of the first number of energy threshold levels.

At step 508, the X-ray scanning system 205 is triggered to operate in a second scan mode wherein the X-ray source is triggered to have a relatively high-energy output in order to generate a high-energy X-ray beam for scanning a second object (in some embodiments, the second object may be a portion of the first object, such as a cab/cargo area of a cargo truck, or may the same as the first object). In some embodiments, the high-energy output ranges from 150 keV to 600 keV. In some embodiments, the high-energy X-ray beam has an end-point energy ranging from 50 keV up to the maximum number, which, in some embodiments, may be 600 keV. It should be noted that while some of the energy levels from the low-energy X-ray beam (for example, 1 keV to 500 keV) and those from the high-energy X-ray beam (50 keV to 600 keV) overlap, the overall ranges are relatively low for the former and relatively high for the latter.

At step 510, in response to the X-ray scanning system 205 operating in the second scan mode, the AB module 225 automatically modulates (as it is configured to do so) the first binning scheme and implements a second binning scheme for optimized energy-resolution. The second binning scheme includes a second number of energy-resolving bins having associated therewith a second number of energy threshold levels, wherein the second number of energy threshold levels is 1 less than the second number of energy-resolving bins. In some embodiments, the second number of energy-resolving bins is at least 5. In some embodiments, the second number of energy-resolving bins is equal to the first number of energy-resolving bins. In some embodiments, the second number of energy-resolving bins is not equal to the first number of energy-resolving bins. In some embodiments, the second number of energy-resolving bins is greater than the first number of energy-resolving bins. In some embodiments, the second number of energy-resolving bins is less than the first number of energy-resolving bins. In some embodiments, each of the second number of energy threshold levels, in the second binning scheme, is skewed or shifted towards a higher energy (within the maximum source energy output) compared to the energy of each of the first number of energy threshold levels.

At step 512, the high-energy X-ray beam is swept once to scan the second object and a second count of X-ray photons reaching the PCD is determined for each of the second number of energy-resolving bins. The count of X-ray photons is performed based on a comparison of an energy of an X-ray photon and the energy intervals of the second number of energy threshold levels.

If, at step 513, it is determined that two or more lower energy-resolving bins of the second number of energy-resolving bins have photon counts of zero or ST (which may be due to the second object being highly attenuating), then the flow moves to step 514a and 516a else the flow moves to step 514b.

At step 514a, the AB module 225 automatically modulates (as it is configured to do so) the second binning scheme and implements a third binning scheme for optimized energy-resolution. The third binning scheme includes a third number of energy-resolving bins having associated third number of energy threshold levels, wherein the third number of energy threshold levels is 1 less than the third number of energy-resolving bins. In some embodiments, the third number of energy-resolving bins is at least 5. In some embodiments, the third number of energy-resolving bins is equal to the second number of energy-resolving bins. In some embodiments, the third number of energy-resolving bins is not equal to the second number of energy-resolving bins. In some embodiments, the third number of energy-resolving bins is greater than the second number of energy-resolving bins. In some embodiments, the third number of energy-resolving bins is less than the second number of energy-resolving bins. In some embodiments, each of the third number of energy threshold levels, in the third binning scheme, is further skewed or shifted towards an even higher energy (within the maximum source energy output) compared to the energy of each of the second number of energy threshold levels. At step 516a, the high-energy X-ray beam is swept continuously to scan the second object and a third count of X-ray photons reaching the PCD is determined for each of the third number of energy-resolving bins.

Alternatively, at step 514b, the high-energy X-ray beam is swept continuously to scan the second object and a fourth count of X-ray photons reaching the PCD is determined for each of the second number of energy-resolving bins. In this case, none of the lower energy-resolving bins of the second number of energy-resolving bins has photon counts of zero (or ≤T).

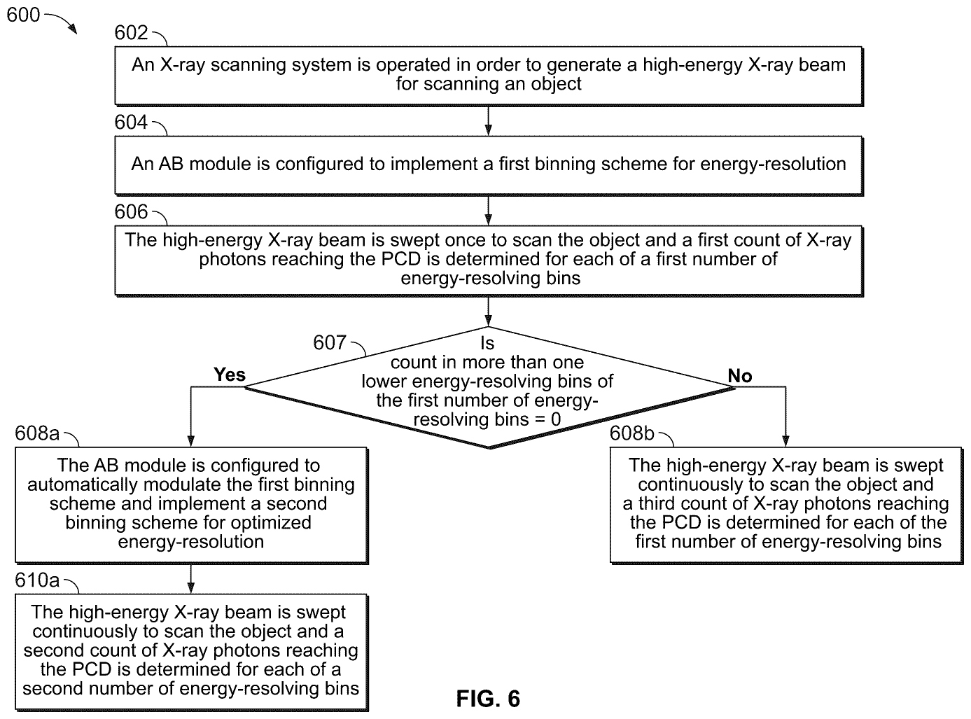

FIG. 6 is a flowchart detailing a plurality of steps of a method 600 for improved energy resolving capabilities of the photon-counting detector (PCD) of the X-ray scanning system 205, in accordance with some embodiments of the present specification. In some embodiments, processor 210 is configured to implement the steps of method 600.

Referring now to FIGS. 2 and 6, at step 602, the X-ray scanning system 205 generates a high-energy X-ray beam for scanning an object. In some embodiments, the source energy output ranges from 50 keV to 600 keV. In some embodiments, the high-energy X-ray beam has an end-point energy ranging from 50 to 600 keV or up to the maximum value.

At step 604, the AB module 225 is configured to implement a first binning scheme for energy-resolution. The first binning scheme includes a first number of energy-resolving bins having associated first number of energy threshold levels, wherein the first number of energy threshold levels is 1 less than the first number of energy-resolving bins. In some embodiments, the first number of energy-resolving bins is at least 5. In some embodiments, the first number of energy threshold levels have approximately equal energy increments between the minimum and maximum source energy outputs.

At step 606, the high-energy X-ray beam is swept once to scan the object and a first count of X-ray photons reaching the PCD is determined for each of the first number of energy-resolving bins. The count of X-ray photons is performed based on a comparison of an energy of an X-ray photon and the energy intervals of the first number of energy threshold levels.

If, at step 607, it is determined whether two or more lower energy-resolving bins of the first number of energy-resolving bins have photon counts of zero or ST (which may be due to the object being highly attenuating), then the flow moves to step 608a and 610a, else the flow moves to step 608b.

At step 608a, the AB module 225 automatically modulates (as it is configured to do so) the first binning scheme and implements a second binning scheme for optimized energy-resolution. The second binning scheme includes a second number of energy-resolving bins having associated second number of energy threshold levels, wherein the second number of energy threshold levels is 1 less than the second number of energy-resolving bins. In some embodiments, the second number of energy-resolving bins is at least 5. In some embodiments, the second number of energy-resolving bins is equal to the first number of energy-resolving bins. In some embodiments, the second number of energy-resolving bins is not equal to the first number of energy-resolving bins. In some embodiments, the second number of energy-resolving bins is greater than the first number of energy-resolving bins. In some embodiments, the second number of energy-resolving bins is less than the first number of energy-resolving bins. In some embodiments, each of the second number of energy threshold levels, in the second binning scheme, is skewed or shifted towards a higher energy (within the maximum source energy output) compared to the energy of each of the first number of energy threshold levels.

At step 610a, the high-energy X-ray beam is swept continuously to scan the object and a second count of X-ray photons reaching the PCD is determined for each of the second number of energy-resolving bins.

Alternatively, at step 608b, the high-energy X-ray beam is swept continuously to scan the object and a third count of X-ray photons reaching the PCD is determined for each of the first number of energy-resolving bins. In this case, none of the lower energy-resolving bins of the first number of energy-resolving bins has photon counts of zero.

Thus, the systems and methods of the present specification are directed towards improving energy-resolving capabilities of PCDs that use at least 5 levels of binning, with standard cargo pitch scintillator crystals-based detector elements or pixels and a high rate dedicated ASIC for digital conversion. The higher level of energy binning is advantageous in that it enables at least the following benefits. The systems and methods of the present specification enable scatter rejection of very low-energy scatter signal(s) that tend to result in corruption of the transmission data and reduction of material separation confidence. The systems and methods afford more layers of material separation that has the potential to add a level of enhanced organic separation between hydrogenous and carbon-based organics. And further, the systems and methods of the present specification support the ability to on-the-fly, adjust bin thresholds to accommodate different scan conveyances and to accommodate different X-ray source energy outputs.

The above examples are merely illustrative of the many applications of the systems and methods of the present specification. Although only a few embodiments of the present invention have been described herein, it should be understood that the present invention might be embodied in many other specific forms without departing from the spirit or scope of the invention. Therefore, the present examples and embodiments are to be considered as illustrative and not restrictive, and the invention may be modified within the scope of the appended claims.

What is claimed is:

1. A computer implemented method for scanning an object, wherein the method is implemented by a plurality of programmatic instructions stored in a non-transient memory and wherein, when executed by at least one processor, the plurality of programmatic instructions cause:
an X-ray source to sweep the object with a first X-ray beam;
a first set of energy-resolving bins to be generated, wherein each of the first set of energy-resolving bins is defined by an energy range and is configured to receive data indicative of photons detected by a detector assembly as a result of the first X-ray beam interacting with the object;
said data indicative of the photons in each of the first set of energy-resolving bins to be analyzed;
a second set of energy-resolving bins to be generated based on said analysis, wherein at least one of a) a number of the second set of energy-resolving bins is different than a number of the first set of energy-resolving bins and b) one or more of the second set of energy-resolving bins is defined by an energy range that is different than one or more of the energy ranges of the first set of energy-resolving bins; and
the X-ray source to sweep the object with a second X-ray beam.

2. The computer implemented method of claim 1, wherein said data indicative of the photons in each of the first set of energy-resolving bins is analyzed by counting the photons in each of the first set of energy-resolving bins.

3. The computer implemented method of claim 1, wherein said second set of energy-resolving bins is generated only if two or more of the first set of energy-resolving bins has a count of said photons below a threshold number.

4. The computer implemented method of claim 1, wherein the threshold number is 1.

5. The computer implemented method of claim 1, wherein the first set of energy-resolving bins comprises at least 5 bins and the second set of energy-resolving bins comprises at least 5 bins.

6. The computer implemented method of claim 1, wherein at least a portion of the energy ranges of the second set of energy-resolving bins is shifted to different values relative to the energy ranges of the first set of energy-resolving bins.

7. The computer implemented method of claim 1, wherein the X-ray source is a high-energy X-ray source and wherein the first X-ray beam has an end-point energy ranging from 50 to 600 keV.

8. The computer implemented method of claim 7, wherein the object is a portion of a cargo vehicle that is not occupied by a human being.

9. The computer implemented method of claim 8, wherein, when executed by the at least one processor, the plurality of programmatic instructions further cause:
a low-energy X-ray source to sweep a portion of the cargo vehicle that is occupied by a human being with a low-energy X-ray beam prior to the high-energy X-ray source sweeping the object with the first X-ray beam; and
a third set of energy-resolving bins to be generated, wherein each of the third set of energy-resolving bins is defined by an energy range and is configured to receive data indicative of photons detected by the detector assembly as a result of the low-energy X-ray beam interacting with the occupied portion of the cargo vehicle.

10. The computer implemented method of claim 9, wherein at least one of a) a number of the third set of energy-resolving bins is different than the number of the first set of energy-resolving bins or the number of the second set of energy-resolving bins and b) one or more of the third set of energy-resolving bins is defined by an energy range that is different than one or more of the energy ranges of the first set of energy-resolving bins or one or more of the energy ranges of the second set of energy-resolving bins.

11. An X-ray scanning system for scanning an object, comprising:
an X-ray source comprising a first X-ray beam and a second X-ray beam;
a detector assembly positioned to receive X-ray photons generated as a result of the first X-ray beam interacting with the object during a first scan mode and X-ray photons generated as a result of the second X-ray beam interacting with the object during a second scan mode;
at least one processor in data communication with the X-ray source and the detector assembly, wherein the at least one processor is configured to execute a plurality of programmatic instructions to:
sweep the object with the first X-ray beam generated by the X-ray source;
cause a first set of energy-resolving bins to be generated, wherein each of the first set of energy-resolving bins is defined by an energy range and is configured to receive data indicative of the X-ray photons detected by a detector assembly as a result of the first X-ray beam interacting with the object;
analyze said data indicative of the first X-ray photons in each of the first set of energy-resolving bins;
cause a second set of energy-resolving bins to be generated based on said analysis, wherein at least one of a) a number of the second set of energy-resolving bins is different than a number of the first set of energy-resolving bins and b) one or more of the second set of energy-resolving bins is defined by an energy range that is different than one or more of the energy ranges of the first set of energy-resolving bins; and
sweep the object with the second X-ray beam generated by the X-ray source.

12. The system of claim 11, wherein said data indicative of the photons in each of the first set of energy-resolving bins is analyzed by counting the photons in each of the first set of energy-resolving bins.

13. The system of claim 11, wherein said second set of energy-resolving bins is generated only if two or more of the first set of energy-resolving bins has a count of said photons below a threshold number.

14. The system of claim 13, wherein the threshold number is 1.

15. The system of claim 11, wherein the first set of energy-resolving bins comprises at least 5 bins and the second set of energy-resolving bins comprises at least 5 bins.

16. The system of claim 11, wherein at least a portion of the energy ranges of the second set of energy-resolving bins is shifted to different values relative to the energy ranges of the first set of energy-resolving bins.

17. The system of claim 11, wherein the X-ray source is a high-energy X-ray source and wherein the first X-ray beam has an end-point energy ranging from 50 to 600 keV.

18. The system of claim 17, wherein the object is a portion of a cargo vehicle that is not occupied by a human being.

19. The system of claim 18, wherein, the at least one processor, further executes a plurality of programmatic instructions to cause:
a low-energy X-ray source to sweep a portion of the cargo vehicle that is occupied by a human being with a low-energy X-ray beam prior to the high-energy X-ray source sweeping the object with the first X-ray beam; and
a third set of energy-resolving bins to be generated, wherein each of the third set of energy-resolving bins is defined by an energy range and is configured to receive data indicative of photons detected by the detector assembly as a result of the low-energy X-ray beam interacting with the occupied portion of the cargo vehicle.

20. The system of claim 19, wherein at least one of a) a number of the third set of energy-resolving bins is different than the number of the first set of energy-resolving bins or the number of the second set of energy-resolving bins and b) one or more of the third set of energy-resolving bins is defined by an energy range that is different than one or more of the energy ranges of the first set of energy-resolving bins or one or more of the energy ranges of the second set of energy-resolving bins.
